(19) United States
(12) Patent Application Publication
(10) Pub. No.: US 2024/0276370 A1
(43) Pub. Date: Aug. 15, 2024

(54) SYSTEMS AND METHOD FOR EARLY TERMINATION INDICATION OF TARGET WAKE TIME (TWT) SERVICE PERIOD (SP)

(71) Applicant: Meta Platforms Technologies, LLC, Menlo Park, CA (US)

(72) Inventors: Muhammad Kumail Haider, Sunnyvale, CA (US); Chunyu Hu, Saratoga, CA (US); Binita Gupta, San Diego, CA (US)

(73) Assignee: Meta Platforms Technologies, LLC, Menlo Park, CA (US)

(21) Appl. No.: 18/400,147

(22) Filed: Dec. 29, 2023

Related U.S. Application Data
(60) Provisional application No. 63/445,895, filed on Feb. 15, 2023.

(51) Int. Cl. H04W 52/02; H04W 28/02

(52) U.S. Cl. CPC H04W 52/0216; H04W 28/0221; H04W 84/12

(57) ABSTRACT

A first device may include one or more processors. The one or more processors may be configured to generate, during a service period of a target wake time (TWT) schedule, a first frame indicating, to an access point in a wireless local area network (WLAN), that the first device is ready to terminate the service period. The one or more processors may be configured to wirelessly transmit, via a transceiver, the generated first frame to the access point.

### CROSS-REFERENCE TO RELATED APPLICATION

This application claims priority to U.S. Provisional Patent Application No. 63/445,895 filed on Feb. 15, 2023, which is incorporated by reference herein in its entirety for all purposes.

### FIELD OF DISCLOSURE

The present disclosure is generally related to communications, including but not limited to systems and methods of indicating early termination of a target wake time (TWT) service period (SP).

### BACKGROUND

Artificial reality, such as a virtual reality (VR), an augmented reality (AR), or a mixed reality (MR), provides immersive experience to a user. In one example, a user wearing a head wearable display (HWD) can turn the user's head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device may have access to a network.

### SUMMARY

Various embodiments disclosed herein are related to a first device including one or more processors. In some embodiments, the one or more processors may be configured to generate, during a service period of a target wake time (TWT) schedule, a first frame indicating, to an access point in a wireless local area network (WLAN), that the first device is ready to terminate the service period. The one or more processors may be configured to wirelessly transmit, via a transceiver, the generated first frame to the access point.

In some embodiments, the first frame may include a quality of service (QOS) control field that includes a first field. In generating the first frame, the one or more processors may be configured to set the first field to a value indicating that the first device is ready to terminate the service period. The first frame may be a QoS null frame. The first field may be a bit included in the QoS control field.

In some embodiments, the first frame may include a second field indicating a buffer size of traffic corresponding a traffic identifier (TID). In generating the first frame, the one or more processors may be configured to set the second field to a value indicating that the first device is ready to terminate the service period.

In some embodiments, the first frame may include a third field indicating a total buffer size of traffic corresponding a plurality of TIDs. In generating the first frame, the one or more processors are configured to set the third field to a value indicating that the first device is ready to terminate the service period.

In some embodiments, the one or more processors may be further configured to wirelessly receive, via the transceiver from the access point, a second frame. In response to the second frame, the one or more processors may be configured to generate the first frame.

Various embodiments disclosed herein are related to an access point including one or more processors and/or a transceiver. In some embodiments, the one or more processors may be configured to wirelessly receive, during a service period of a target wake time (TWT) schedule, via a transceiver from a first device in a wireless local area network (WLAN), a first frame indicating that the first device is ready to terminate the service period. In response to the first frame, the one or more processors may be configured to determine whether the access point has pending traffic for the first device for a remainder of the service period. In response to determining that the access point does not have pending traffic for the first device for the remainder of the service period, the one or more processors may be configured to wirelessly transmit, via the transceiver, a second frame indicating that the service period has been terminated.

In some embodiments, in response to determining that the access point has pending traffic for the first device for the remainder of the service period, the one or more processors may be further configured to wirelessly transmit, via the transceiver to the first device, the pending traffic. In response to transmitting the pending traffic, the one or more processors may be further configured to wirelessly transmit, via the transceiver, a third frame indicating that the service period has been terminated.

In some embodiments, the first frame may include a quality of service (QOS) control field that includes a first field. The first field may be set to a value indicating that the first device is ready to terminate the service period. The first frame may be a QoS null frame. The first field may be a bit included in the QoS control field.

In some embodiments, the first frame may include a second field indicating a buffer size of traffic corresponding a traffic identifier (TID). The second field may be set to a value indicating that the first device is ready to terminate the service period.

In some embodiments, the first frame may include a third field indicating a total buffer size of traffic corresponding a plurality of TIDs. The third field may be set to a value indicating that the first device is ready to terminate the service period.

In some embodiments, the one or more processors may be further configured to wirelessly send, via the transceiver of the access point, a fourth frame. In response to the fourth frame, the one or more processors may be further configured to wirelessly receive, via the transceiver, the first frame.

Various embodiments disclosed herein are related to a method including during a service period of a target wake time (TWT) schedule, wirelessly receiving, by an access point from a first device in a wireless local area network (WLAN), a first frame indicating that the first device is ready to terminate the service period. The method may include in response to the first frame, determining, by the access point, whether the access point has pending traffic for the first device for a remainder of the service period. The method may include in response to determining that the access point does not have pending traffic for the first device for the remainder of the service period, wirelessly transmitting, by the access point, a second frame indicating that the service period has been terminated.

In some embodiments, in response to determining that the access point has pending traffic for the first device for the remainder of the service period, the access point may wirelessly transmit, to the first device, the pending traffic. In response to transmitting the pending traffic, the access point may wirelessly transmit a third frame indicating that the service period has been terminated.

In some embodiments, the first frame may include a quality of service (QOS) control field that includes a first field. The first field may be set to a value indicating that the first device is ready to terminate the service period. The first frame may be a QoS null frame. The first field may be a bit included in the QoS control field.

In some embodiments, the first frame may include a second field indicating a buffer size of traffic corresponding a traffic identifier (TID). The second field may be set to a value indicating that the first device is ready to terminate the service period.

In some embodiments, the first frame may include a third field indicating a total buffer size of traffic corresponding a plurality of TIDs. The third field may be set to a value indicating that the first device is ready to terminate the service period.

In some embodiments, the access point may wirelessly send a fourth frame. In response to the fourth frame, the access point may wirelessly receive the first frame.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing target wake time (TWT), according to an example implementation of the present disclosure.

FIG. 5 illustrates an example quality of service (QOS) control field format for indicating early termination of a target wake time (TWT) service period (SP), according to an example implementation of the present disclosure.

FIG. 6 illustrates another example QoS control field format for indicating early termination of a TWT SP, according to an example implementation of the present disclosure.

FIG. 7 illustrates an example format of an aggregate control (A-control) subfield of a control field for indicating early termination of a TWT SP, according to an example implementation of the present disclosure.

FIG. 8A and FIG. 8B illustrate example frame sequences for early termination of a TWT SP, according to an example implementation of the present disclosure.

FIG. 9 is a flowchart showing a process of performing early termination of a TWT SP, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

TWT can be a time agreed/negotiated upon by devices (e.g., access points (APs) and/or stations (STAs)), or specified/configured by one device (e.g., an AP). During the wake time, a first device (e.g., a STA) may be in an awake state (e.g., its wireless communication module/interface is in a fully powered-up ready, or wake state) and is able to transmit and/or receive. When the first device is not awake (e.g., its wireless communication module/interface is in a powered-down, low power, or sleep state), the first device may enter a low power mode or other sleep mode. The first device may exist in the sleep state until a time instance/window as specified by the TWT.

TWT is a mechanism where a set of service periods (SPs) are defined and shared between devices to reduce medium contention and improve the power efficiency of the devices. For example, the first device can wake up periodically (e.g., at a fixed, configured time interval/period/cycle) based on the TWT. The TWT reduces energy consumption of the devices by limiting the awake time and associated power consumption of the devices.

An AP (e.g., AP and/or other device operating as a soft AP/hotspot) may enhance medium access protection and resource reservation by supporting restricted TWT (R-TWT). The R-TWT SPs may be used to deliver latency sensitive traffic and/or any additional frame that supports latency sensitive traffic.

Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user's view of the space of the artificial reality according to the sensor measurements, and generate an image of the space of the artificial reality corresponding to the user's view. The console device can transmit the generated image to the HWD, by which the image of the space of the artificial reality corresponding to the user's view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

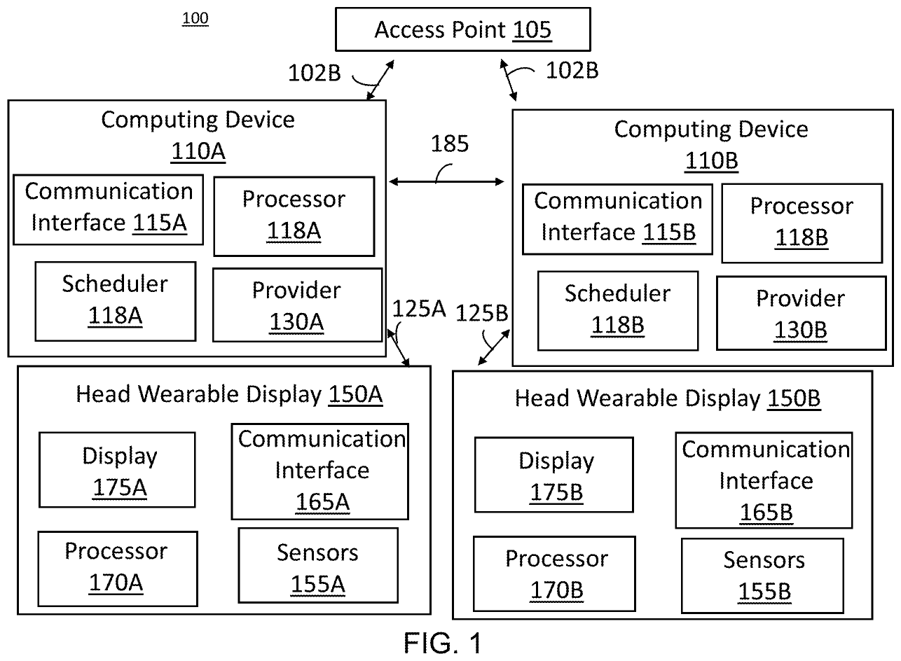

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request R-TWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in R-TWT service periods (SPs). The scheduler 118 of the computing device(s) may schedule (or negotiate) the requested R-TWT SP(s). The scheduler 118 of the computing device(s) may also indicate if the SP(s) are requested only for P2P communication (as compared to mixed P2P communication and non-P2P communication).

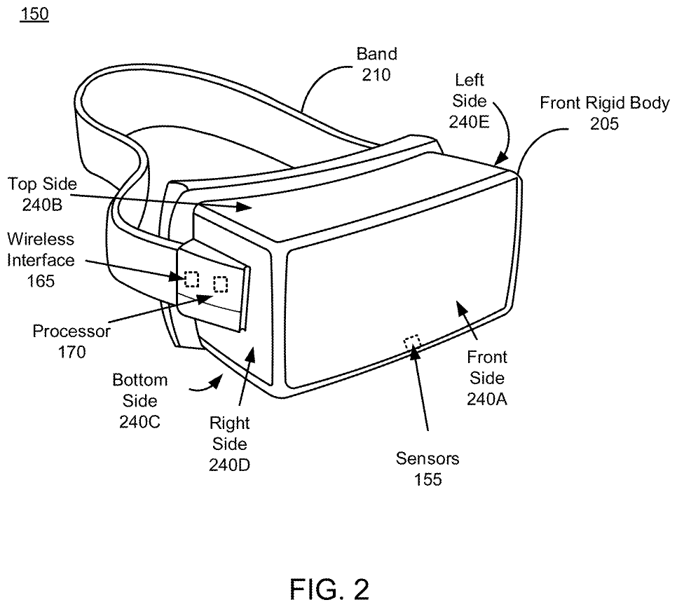

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

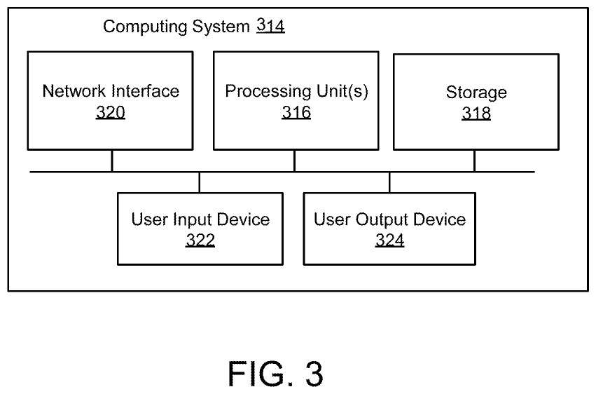

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

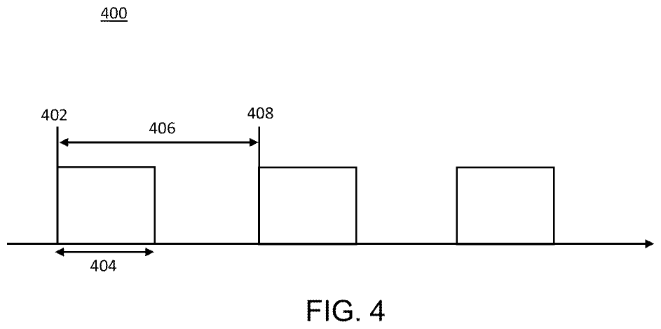

FIGS. 1-2 illustrate devices that communicate traffic streams some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406.

A TWT schedule may be communicated and/or negotiated using broadcast TWT (B-TWT) and/or individual TWT (I-TWT) signaling. In some embodiments, to signal I-TWT, TWT schedule information may be communicated to particular (individual) devices using a mode such as a Network Allocation Vector (NAV) to protect the medium access of TWT SPs. In contrast, to signal B-TWT, in some embodiments, a device (such as AP 105) may schedule TWT SPs with other devices (e.g., computing devices 110 and/or HWDs 150) and may share schedule information in beacon frames and/or probe response frames. Sharing schedule information using B-TWT may reduce overhead (e.g., negotiation overhead) as compared to the overhead used when sharing information using I-TWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or R-TWT) in P2P communication. Accordingly, a P2P model where a P2P STA (e.g., a HWD 150) is not associated with an infra-basic service set (BSS) AP, may improve P2P communication. Without AP's assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

In one aspect, an access point (AP) can terminate an ongoing TWT SP (e.g., current TWT SP) by sending a notification that terminates the ongoing SP. An AP may indicate an early termination of an SP by setting an end of service period (EOSP) subfield (e.g., bit 4 of a quality of service (QOS) control field) to 1 in specific frames. An AP may indicate/request/initiate an early termination of an SP by setting a More Data subfield (e.g., bit 13 of a frame control field) to 0 in specific frames. An (early) SP termination has several advantages. For example, a TWT scheduled STA can remain awake from the start of an SP until (1) the end of the SP or (2) an AP indicates an SP termination. If a STA has already delivered and/or received traffic intended for the SP, the STA can sleep (e.g., switch to an inactive state) after the early SP termination and can save power.

In the conventional early SP termination framework, only an AP can terminate an SP, and a STA may not have the ability to terminate an SP. For example, the AP may not wait for any indication from the STA and may terminate anytime the AP decides. That is, SP termination may not be a handshake. It would be beneficial for a STA to have a method/way of indication to the AP that the STA is ready to terminate the SP or the STA is requesting an early termination.

To address this problem, systems and/or methods for indicating early termination of a TWT SP may be provided/defined. In some embodiments, a system can provide a technique for a STA to explicitly indicate about readiness, intention and/or request to terminate an on-going SP of a TWT (e.g., B-TWT (broadcast TWT) or R-TWT (restricted TWT)). In some embodiments, an AP can terminate regardless of what the STA has signaled (even if the AP has not received from a STA an indication to terminate a TWT SP). For example, if the AP sends a notification to terminate a TWT SP, the AP's notification can take priority and terminate the TWT SP regardless of whether the AP receives an early SP termination indication from a STA or not.

In one approach, a new “EOT” (end of traffic) subfield or a new “EOTSP” (end of traffic for service period) subfield as early SP termination indication may be defined in a QoS (quality of service) control field. In some embodiments, a STA may send this early SP termination indication as an unsolicited response. A QoS control field may be carried in a medium access control (MAC) header in QoS Null frames or QoS data frames. QoS Null frames may have a “reserved” subfield in the QoS control field (e.g., bit 7 of the QoS control field) while QoS data frames may not have a “reserved” subfield in the QoS control field. In some embodiments, the reserved bit may be redefined as “EOT” (End of Traffic) subfield or “EOTSP” (end of traffic for service period) subfield or any other subfield with a different name. In some embodiments, a subfield other than the reserved bit (in the MAC header in QoS Data frames or QOS NULL frames) may be redefined as “EOT” subfield or “EOTSP” subfield.

In some embodiments, a QoS control field may include a first subfield (bits 0-3), a second subfield (bit 4), a third subfield (bits 5-6), a fourth subfield (bit 7), and/or a fifth subfield (bits 8-15). The STA may set the subfields of the QoS control field depending on the frame subtype of a frame. For example, if the frame subtype is QOS Null frame, the STA may set (1) the first subfield to a TID; (2) the second subfield to 0; (3) the third subfield to an Ack policy indicator; and/or (4) the fifth subfield to transmission opportunity (TXOP) duration requested for the TID set in the first subfield. The STA can indicate to terminate a TWT SP using the QoS control field. In some embodiments, the STA can set (1) the frame subtype to QoS Null frame; (2) the first subfield to a TID; (3) the second subfield to 1; (4) the third subfield to an Ack policy indicator; (5) the fourth subfield as “EOT” (end of traffic) subfield to a value indicating early SP termination; and/or (6) the fifth subfield to a queue size of traffic for the TID set in the first subfield.

In some embodiments, the EOT subfield may indicate whether there is pending traffic from the transmitting STA during the current SP. For example, the EOT subfield may be set to 1 if the transmitting STA does not have any more pending traffic to be delivered during the current SP; otherwise, the EOT subfield may be set to 0. In other words, the STA may set the EOT subfield to 1 during an on-going TWT SP to indicate to the AP or a peer STA (e.g., using individual TWT) that the STA does not have any pending traffic for the remainder of the current TWT SP.

In some embodiment, the AP may not (early) terminate an on-going SP until the AP receives an EOT indication (using the EOT subfield) from the STA. If the AP receives the EOT indication from the STA and the AP does not have more pending traffic for the STA, the AP may early terminate the SP.

In one approach, the system may allow a STA to implicitly indicate (readiness, intention and/or request of) early termination of a TWT SP using zero buffer status. In some embodiments, a STA may perform buffer status reporting (BSR) by reporting a buffer status to an AP. A buffer status may be a quantitative indication of how much traffic (QOS data) is queued up at the STA. The STA may indicate buffer status in (bytes) by including either of the following fields in frames sent to the AP: (1) QOS control field (e.g., buffer status per TID); or (2) BSR control field (e.g., buffer status per access category (AC) such that more than one TID (e.g., two TIDs) can be mapped to one AC).

In some embodiments, a QoS control field may include a first subfield (bits 0-3), a second subfield (bit 4), a third subfield (bits 5-6), a fourth subfield (bit 7), and/or a fifth subfield (bits 8-15). The STA may set the subfields of the QoS control field depending on the frame subtype of a frame. For example, if the frame subtype is QOS Data frame, the STA may set (1) the first subfield to a TID; (2) the second subfield to 0; (3) the third subfield to an Ack policy indicator; (4) the fourth subfield to a value indicating that that A-MSDU (aggregated MAC service data unit) is present; and/or (5) the fifth subfield to a TXOP duration requested for the TID set in the first subfield. If the frame subtype is QOS Data frame, the STA may set (1) the first subfield to a TID; (2) the second subfield to 1; (3) the third subfield to an Ack policy indicator; (4) the fourth subfield to a value indicating that that A-MSDU is present; and/or (5) the fifth subfield to a queue size of UL traffic for the TID set in the first subfield.

In some embodiments, if the frame subtype is QOS Null frame, the STA may set (1) the first subfield to a TID; (2) the second subfield to 0; (3) the third subfield to an Ack policy indicator; and/or (4) the fifth subfield to a TXOP duration requested for the TID set in the first subfield. If the frame subtype is QOS Null frame, the STA may set (1) the first subfield to a TID; (2) the second subfield to 1; (3) the third subfield to an Ack policy indicator; and/or (4) the fifth subfield to a queue size of UL traffic for the TID set in the first subfield. In this manner, the STA can report a buffer status via the QoS control field by reporting a queue size of UL traffic per TID. The STA may indicate buffer status in response to a buffer status report polling (BSRP) trigger frame or as an unsolicited response.

In some embodiments, an aggregate control (A-control) subfield of a High Efficiency (HE) variant High Throughput (HT) control field may include the fields of a plurality of HE controls (including HE control-1, HE control-2, . . . , HE control-N) and a padding. Each HE control may include the fields of control ID and control information. For BSR response, the control ID field may be set to a value (e.g., 3) indicating BSR (see Table 1). The control information field (or BSR control field) may include the subfields of ACI (Access Category Identifier) bitmap, delta TID, ACI high, scaling factor, queue size high, and/or queue size all. For example, in response to a buffer status report request (e.g., BSRP trigger frame) from an AP, a receiver STA may report its buffer status by specifying a queue size in the ‘queue size all’ subfield of a frame and sending the frame to the AP. Queue sizes may be reported for ACI indicated in the ACI bitmap subfield, which indicates the access category (or access categories) for which data stored in the STA's buffer is intended. Each bit of the ACI bitmap subfield can indicate the presence of a service intended for a corresponding AC. A value set in the delta TID subfield may indicate the number of TIDs corresponding to the number of bits in the ACI bitmap subfield that are set to 1. For example, if (1) the number of bits in the ACI bitmap subfield that are set to 1 equals 1, and (2) the delta TID is set to value 1, the delta TID may indicate 2 TIDs. If the number of bits in the ACI bitmap subfield that are set to 1 equals 0, values 0 to 2 in the delta TID may not be applicable, e.g., may not indicate the number of TIDs. A value set in the queue size all subfield may indicate/report a combined queue size of all ACs indicated in the ACI bitmap subfield. A value set in the queue size high subfield may indicate/report a queue size of ACI indicated in the ACI high subfield. In this manner, a queue size may be indicated for a specific AC (e.g., using the queue size high subfield), and/or for all backlogged traffic (e.g., using the queue size all subfield).

TABLE 1
Control ID subfield values

| | | Length of the control |
|---|---|---|
| Control ID | | information |
| value | Meaning | subfield (bits) |
| 0 | Triggered response scheduling (TRS) | 26 |
| 1 | Operating mode (OM) | 12 |
| 2 | HE link adaptation (HLA) | 26 |
| 3 | Buffer status report (BSR) | 26 |
| 4 | UL power headroom (UPH) | 8 |
| 5 | Bandwidth query report (BQR) | 10 |
| 6 | Command and status (CAS) | 8 |
| 7-14 | Reserved | |
| 15 | Ones need expansion surely (ONES) | 26 |

In some embodiments, the system may allow/configure/request a STA to indicate (readiness, intention and/or request of) early termination of a TWT SP using zero buffer status for all traffic (e.g., all TIDs). If a STA indicates zero buffer status for all TIDs (or ACs) associated with an on-going SP, the zero buffer status indication may serve as EOT indication which indicates that STA has no more traffic to deliver during the on-going SP (e.g., the buffer queue is empty or the buffer size is zero).

In some embodiments, using a QoS control field, a STA may indicate zero buffer status for all TIDs. For example, for each TID of the all TIDs, the STA may indicate zero buffer status by setting (1) the first field to a TID; (2) the second field to 1; and (3) the fifth subfield to zero (e.g., zero buffer status/queue size). In some embodiments, the STA may indicate zero buffer status by aggregating multiple QoS control fields in a single frame.

In some embodiments, using a BSR control subfield, a STA may indicate zero buffer status for all ACs in separate fields (e.g., different TIDs). For example, for each TID of the all TIDs, the STA may indicate zero buffer status by setting (1) the ACI high subfield to a TID; and (2) the queue size high subfield to 0 (e.g., zero buffer status/queue size). In some embodiments, the STA may indicate zero buffer status by setting the queue size all subfield to 0 (e.g., zero buffer status/queue size).

In some embodiments, for R-TWT, a zero buffer status indication corresponding only to R-TWT uplink (UL) TIDs (which can be negotiated during the R-TWT setup) may serve as EOT indication (e.g., SP termination readiness indication). For other TWT schedules (e.g., I-TWT/B-TWT), a zero buffer status indication may serve as EOT indication for all TIDs. In some embodiments, (1) if an AP receives a zero buffer status indication in BSR (e.g., no pending traffic indicated in BSR) for all TIDs corresponding to an on-going SP and (2) if the AP has also delivered all traffic in download (DL) to the STA, the AP may terminate the SP.

In some embodiments, the system may allow a STA to indicate (readiness, intention and/or request of) early termination of a TWT SP using zero buffer status for any TID. BSR may be primarily used for UL multi-user (MU) scheduling, and a STA may deliver BSR of any TID when triggered by an AP, or deliver BSR of any TID in unsolicited manner. If the STA has delivered all traffic for some TIDs and has pending traffic for some other TIDs, the STA may keep delivering non-zero buffer status for remaining traffic. In some embodiments, to indicate early termination of a TWT SP, the STA may deliver zero buffer status of any TID only when the STA has finished delivering traffic for the on-going SP. In this manner, zero buffer status received during an on-going SP may serve as EOT indication (e.g., SP termination readiness indication). In some embodiments, a STA may deliver zero buffer status (for any TID or any AC or all ACs) during an on-going TWT SP to indicate to the AP or a peer STA that the STA does not have any pending traffic for the remainder of the on-going TWT SP. In some embodiments, if an AP receives zero buffer status from a STA during an on-going SP, the AP may terminate the SP for the corresponding STA.

One drawback of early SP termination indication using BSR is that buffer status/size of the STA at a certain time instant may be zero, but the STA may be expecting traffic and hence may not want to terminate the SP. This is especially problematic when the AP solicits a buffer report e.g., via BSRP trigger frames. In some embodiments, a STA can indicate (readiness, intention and/or request of) early termination of a TWT SP using zero buffer status for all traffic (e.g., all TIDs), only when delivering the zero buffer status as an unsolicited response. In some embodiments, (1) if an AP receives a zero buffer status indication in BSR for all TIDs corresponding to an on-going SP as an unsolicited response, and (2) if the AP has also delivered all traffic to the STA, the AP may terminate the SP. Similarly, a STA can indicate (readiness, intention and/or request of) early termination of a TWT SP using zero buffer status for any TID, only when delivering the zero buffer status as an unsolicited response. In some embodiments, (1) if an AP receives a zero buffer status indication in BSR for any TID corresponding to an on-going SP as an unsolicited response, and (2) if the AP has also delivered all traffic to the STA, the AP may terminate the SP.

In some embodiments, at a first step, a STA may send an indication of early termination of an on-going SP of a TWT (e.g., using either EOT subfield, QoS control field, solicited zero buffer status report, unsolicited zero buffer status report). At a second step, the AP may determine that the AP has no more traffic in DL for the STA for the remainder of the on-going SP. At a third step, the AP may send an SP termination notification to the STA. At a fourth step, the on-going SP of the TWT may be terminated.

In some embodiments, at a first step, a STA may send an indication of early termination of an on-going SP of a TWT (e.g., using either EOT subfield, QoS control field, solicited zero buffer status report, unsolicited zero buffer status report). At a second step, the AP may determine that the AP has traffic in DL for the STA for the remainder of the on-going SP. At a third step, the AP may send (all of) the remaining traffic to the STA. At a fourth step, the AP may send an SP termination notification to the STA. In some embodiments, the SP termination notification can be indicated in a last DL data frame sent by the AP. At a fifth step, the on-going SP of the TWT may be terminated. In some embodiments, the AP may terminate an on-going SP only after receiving the early SP termination indication from the STA.

In one approach, a first device may include one or more processors. The one or more processors may generate, during a service period of a target wake time (TWT) schedule, a first frame indicating, to an access point in a wireless local area network (WLAN), that the first device is ready to terminate the service period. The one or more processors may wirelessly transmit, via a transceiver, the generated first frame to the access point.

In some embodiments, the first frame may include a quality of service (QOS) control field that includes a first field. In generating the first frame, the one or more processors may be configured to set the first field to a value indicating that the first device is ready to terminate the service period. The first frame may be a QoS null frame. The first field may be a bit included in the QoS control field.

In some embodiments, the first frame may include a second field indicating a buffer size of traffic corresponding a traffic identifier (TID). In generating the first frame, the one or more processors may be configured to set the second field to a value indicating that the first device is ready to terminate the service period.

In some embodiments, the first frame may include a third field indicating a total buffer size of traffic corresponding a plurality of TIDs. In generating the first frame, the one or more processors are configured to set the third field to a value indicating that the first device is ready to terminate the service period.

In some embodiments, the one or more processors may be further configured to wirelessly receive, via the transceiver from the access point, a second frame. In response to the second frame, the one or more processors may be configured to generate the first frame.

In one approach, an access point may include one or more processors. The one or more processors may wirelessly receive, during a service period of a target wake time (TWT) schedule, via a transceiver from a first device in a wireless local area network (WLAN), a first frame indicating that the first device is ready to terminate the service period. In response to the first frame, the one or more processors may determine whether the access point has pending traffic for the first device for a remainder of the service period. In response to determining that the access point does not have pending traffic for the first device for the remainder of the service period, the one or more processors may wirelessly transmit, via the transceiver, a second frame indicating that the service period has been terminated.

In some embodiments, in response to determining that the access point has pending traffic for the first device for the remainder of the service period, the one or more processors may be further configured to wirelessly transmit, via the transceiver to the first device, the pending traffic. In response to transmitting the pending traffic, the one or more processors may be further configured to wirelessly transmit, via the transceiver, a third frame indicating that the service period has been terminated.

In some embodiments, the first frame may include a quality of service (QOS) control field that includes a first field. The first field may be set to a value indicating that the first device is ready to terminate the service period. The first frame may be a QoS null frame. The first field may be a bit included in the QoS control field.

In some embodiments, the first frame may include a second field indicating a buffer size of traffic corresponding a traffic identifier (TID). The second field may be set to a value indicating that the first device is ready to terminate the service period.

In some embodiments, the first frame may include a third field indicating a total buffer size of traffic corresponding a plurality of TIDs. The third field may be set to a value indicating that the first device is ready to terminate the service period.

In some embodiments, the one or more processors may be further configured to wirelessly send, via the transceiver of the access point, a fourth frame. In response to the fourth frame, the one or more processors may be further configured to wirelessly receive, via the transceiver, the first frame.

Embodiments in the present disclosure have at least the following advantages and benefits. First, embodiments in the present disclosure can provide useful techniques for a STA to send an indication to the AP that the STA is ready to terminate the SP or the STA is requesting an early termination.

Second, embodiments in the present disclosure can provide useful techniques for the AP and the STA to perform a handshake procedure to early terminate an on-going SP of a TWT. For example, upon receiving an early SP termination indication from the STA during an on-going SP of a TWT, the AP may determine whether the AP has more traffic in DL for the STA for the remainder of the on-going SP. In response to determining that the AP does not have traffic in DL for the STA, the AP may send an SP termination notification to the STA so that the on-going SP of the TWT is terminated.

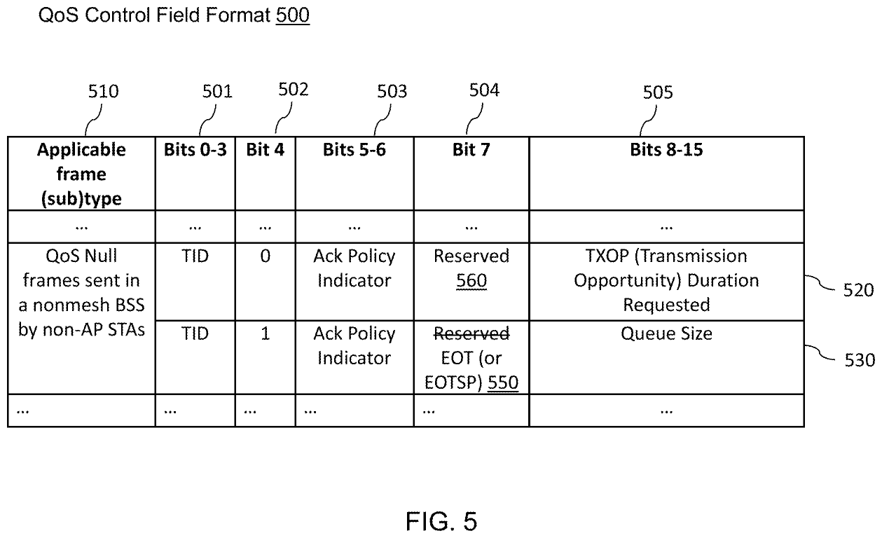

FIG. 5 illustrates an example quality of service (QOS) control field format 500 for indicating early termination of a TWT service period (SP), according to an example implementation of the present disclosure. In some embodiments, a new “EOT” (end of traffic) subfield 550 or a new “EOTSP” (end of traffic for service period) subfield 550 as early SP termination indication may be defined in the QoS control field 500. A STA may send this early SP termination indication (e.g., EOT/EOTSP 550) as an unsolicited response. The QoS control field 500 may be carried in a MAC header in QoS Null frames or QoS data frames. QoS Null frames may have a “reserved” subfield 560 in the QoS control field 500 (e.g., bit 7 of the QoS control field) while QoS data frames may not have a “reserved” subfield in the QoS control field. The reserved bit (e.g., bit 7 of the QoS control field) may be redefined as “EOT” subfield 550 or “EOTSP” subfield 550 or any other subfield with a different name. In some embodiments, a subfield other than the reserved bit (in the MAC header in QoS Data frames or QOS NULL frames) may be redefined as “EOT” subfield or “EOTSP” subfield.

Referring to FIG. 5, the QoS control field 500 may include a first subfield 501 (bits 0-3), a second subfield 502 (bit 4), a third subfield 503 (bits 5-6), a fourth subfield 504 (bit 7), and/or a fifth subfield 505 (bits 8-15). The STA may set the subfields of the QoS control field depending on the frame subtype 510 of a frame. For example, if the frame subtype 510 of a frame 520 is QOS Null frame, the STA may set (1) the first subfield 501 to a TID; (2) the second subfield 502 to 0; (3) the third subfield 503 to an Ack policy indicator; and/or (4) the fifth subfield 505 to transmission opportunity (TXOP) duration requested for the TID set in the first subfield 501 (see the frame 520). The STA can indicate to terminate a TWT SP using the QoS control field by setting (1) the frame subtype 510 to QoS Null frame; (2) the first subfield 501 to a TID; (3) the second subfield 502 to 1; (4) the third subfield 503 to an Ack policy indicator; (5) the fourth subfield 504 as “EOT” subfield or “EOTSP” subfield to a value indicating early SP termination (e.g., a value “1”); and/or (6) the fifth subfield 505 to a queue size of traffic for the TID set in the first subfield 501 (see a frame 530).

In some embodiments, the EOT subfield 550 may indicate whether there is pending traffic from the transmitting STA during the current SP. For example, the EOT subfield 550 may be set to 1 if the transmitting STA does not have any more pending traffic to be delivered during the current SP; otherwise, the EOT subfield 550 may be set to 0. In other words, the STA may set the EOT subfield 550 to 1 during an on-going TWT SP to indicate to the AP or a peer STA (e.g., using individual TWT) that the STA does not have any pending traffic for the remainder of the current TWT SP. In some embodiment, the AP may not (early) terminate an on-going SP until the AP receives an EOT indication (e.g., using the EOT subfield 550) from the STA. If the AP receives the EOT indication from the STA and the AP does not have more pending traffic for the STA, the AP may early terminate the SP.

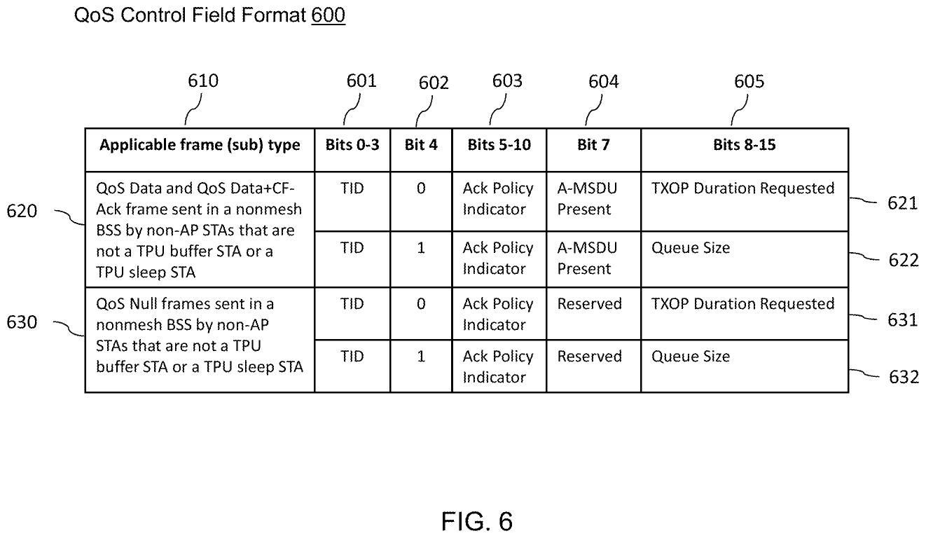

In some embodiments, a system may allow a STA to implicitly indicate (readiness, intention and/or request of) early termination of a TWT SP using zero buffer status. The STA may perform buffer status reporting (BSR) by reporting a buffer status to an AP. A buffer status may be a quantitative indication of how much traffic (QOS data) is queued up at the STA. The STA may indicate buffer status in (bytes) by including either of the following fields in frames sent to the AP: (1) QoS control field (e.g., QoS control field 600 indicating a buffer status per TID in FIG. 6); or (2) BSR control field (e.g., BSR control field 730 indicating a buffer status per access category (AC) such that more than one TID (e.g., two TIDs) can be mapped to one AC).

FIG. 6 illustrates another example QoS control field format 600 for indicating early termination of a TWT SP, according to an example implementation of the present disclosure. The QoS control field 600 may include a first subfield 601 (bits 0-3), a second subfield 602 (bit 4), a third subfield 603 (bits 5-6), a fourth subfield 604 (bit 7), and/or a fifth subfield 605 (bits 8-15). The STA may set the subfields of the QoS control field 600 depending on the frame subtype 610 of a frame. For example, if the frame subtype 610 of a frame 621 is QoS Data frame 620, the STA may set (1) the first subfield 601 to a TID; (2) the second subfield 602 to 0; (3) the third subfield 603 to an Ack policy indicator; (4) the fourth subfield 604 to a value indicating that that A-MSDU is present; and/or (5) the fifth subfield 605 to a TXOP duration requested for the TID set in the first subfield 601. If the frame subtype 610 of a frame 622 is QOS Data frame 620, the STA may set (1) the first subfield 601 to a TID; (2) the second subfield 602 to 1; (3) the third subfield 603 to an Ack policy indicator; (4) the fourth subfield 604 to a value indicating that that A-MSDU is present; and/or (5) the fifth subfield 605 to a queue size of UL traffic for the TID set in the first subfield 601.

Referring to FIG. 6, if the frame subtype 610 of a frame 631 is QOS Null frame 630, the STA may set (1) the first subfield 601 to a TID; (2) the second subfield 602 to 0; (3) the third subfield 603 to an Ack policy indicator; and/or (4) the fifth subfield 605 to a TXOP duration requested for the TID set in the first subfield 601. If the frame subtype 610 of a frame 132 is QoS Null frame 630, the STA may set (1) the first subfield 601 to a TID; (2) the second subfield 602 to 1; (3) the third subfield 603 to an Ack policy indicator; and/or (4) the fifth subfield 605 to a queue size of UL traffic for the TID set in the first subfield 601. In this manner, the STA can report a buffer status via the QoS control field 600 by reporting a queue size of UL traffic per TID (e.g., using the fifth subfield 605). The STA may indicate buffer status in response to a buffer status report polling (BSRP) trigger frame or as an unsolicited response.

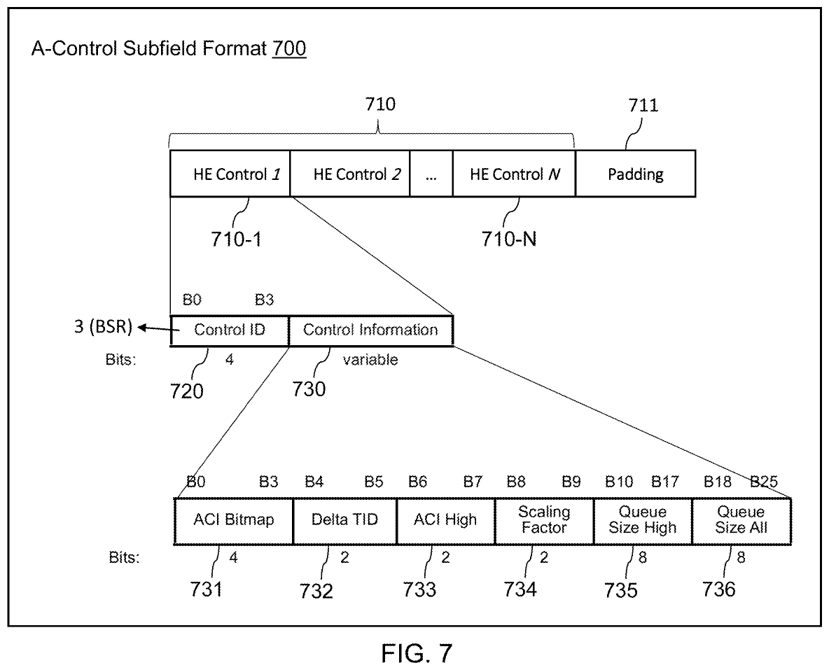

FIG. 7 illustrates an example format of an aggregate control (A-control) subfield 700 of a High Efficiency (HE) variant High Throughput (HT) control field for indicating early termination of a TWT SP, according to an example implementation of the present disclosure. The A-control subfield 700 may include the fields of a plurality of HE controls 710 (including HE control-1 710-1, HE control-2 710-2, . . . , HE control-N 710-N) and a padding 711. Each HE control may include the fields of control ID 720 and control information 730. For BSR response, the control ID field 720 may be set to a value (e.g., 3) indicating BSR (see Table 1). The control information field (or BSR control field) 730 may include the subfields of ACI (Access Category Identifier) bitmap 731, delta TID 732, ACI high 733, scaling factor 734, queue size high 735, and/or queue size all 736. For example, in response to a buffer status report request (e.g., BSRP trigger frame) from an AP, a receiver STA may report its buffer status by specifying a queue size in the ‘queue size all’ subfield 736 of a frame and sending the frame to the AP. Queue sizes may be reported for ACI indicated in the ACI bitmap subfield 731, which indicates the access category (or access categories) for which data stored in the STA's buffer is intended. Each bit of the ACI bitmap subfield 731 can indicate the presence of a service intended for a corresponding AC. A value set in the delta TID subfield 732 may indicate the number of TIDs corresponding to the number of bits in the ACI bitmap subfield 731 that are set to 1. For example, if (1) the number of bits in the ACI bitmap subfield 731 that are set to 1 equals 1, and (2) the delta TID 732 is set to value 1, the delta TID 732 may indicate 2 TIDs. If the number of bits in the ACI bitmap 731 subfield that are set to 1 equals 0, values 0 to 2 in the delta TID 732 may not be applicable, e.g., may not indicate the number of TIDs. A value set in the queue size all subfield 736 may indicate/report a combined queue size of all ACs indicated in the ACI bitmap subfield 731. A value set in the queue size high subfield 735 may indicate/report a queue size of ACI indicated in the ACI high subfield 733. In this manner, a queue size may be indicated for a specific AC (e.g., using the queue size high subfield 735), and/or for all backlogged traffic (e.g., using the queue size all subfield 736).

In some embodiments, a system may allow a STA to indicate (readiness, intention and/or request of) early termination of a TWT SP using zero buffer status for all traffic (e.g., all TIDs). If a STA indicates zero buffer status for all TIDs (or ACs) associated with an on-going SP, the zero buffer status indication may serve as EOT indication which indicates that STA has no more traffic to deliver during the on-going SP. For example, referring to FIG. 6, using a QoS control field 600, a STA may indicate zero buffer status for all TIDs. For example, for each TID of all the TIDs, the STA may indicate zero buffer status by setting (1) the first field 601 to a TID; (2) the second field 602 to 1; and (3) the fifth subfield 605 to zero (e.g., zero buffer status/queue size). In some embodiments, the STA may indicate zero buffer status by aggregating multiple QoS control fields in a single frame. Referring to FIG. 7, using a BSR control subfield 730, a STA may indicate zero buffer status for all ACs in separate fields (e.g., different TIDs). For example, for each TID of all the TIDs, the STA may indicate zero buffer status by setting (1) the ACI high subfield 733 to a TID; and (2) the queue size high subfield 735 to 0 (e.g., zero buffer status/queue size). In some embodiments, the STA may indicate zero buffer status by setting the queue size all subfield 736 to 0 (e.g., zero buffer status/queue size). In some embodiments, for R-TWT, a zero buffer status indication corresponding only to R-TWT uplink (UL) TIDs (which can be negotiated during the R-TWT setup) may serve as EOT indication (e.g., SP termination readiness indication). For other TWT schedules (e.g., I-TWT/B-TWT), a zero buffer status indication may serve as EOT indication for all TIDs. In some embodiments, (1) if an AP receives a zero buffer status indication in BSR (e.g., no pending traffic indicated in BSR) for all TIDs corresponding to an on-going SP (e.g., using the queue size all subfield 736) and (2) if the AP has also delivered all traffic in DL to the STA, the AP may terminate the SP.

In some embodiments, the system may allow a STA to indicate (readiness, intention and/or request of) early termination of a TWT SP using zero buffer status for any TID. BSR may be primarily used for UL multi-user (MU) scheduling, and a STA may deliver BSR of any TID when triggered by an AP, or may deliver BSR of any TID in unsolicited manner. If the STA has delivered all traffic for some TIDs and has pending traffic for some other TIDs, the STA may keep delivering non-zero buffer status for remaining traffic. In order to indicate early termination of a TWT SP, the STA may deliver zero buffer status of any TID (e.g., using the queue size high subfield 735) only when the STA has finished delivering traffic for the on-going SP. In this manner, zero buffer status received during an on-going SP may serve as EOT indication (e.g., SP termination readiness indication). A STA may deliver zero buffer status (for any TID or any AC or all ACs) during an on-going TWT SP to indicate to the AP or a peer STA that the STA does not have any pending traffic for the remainder of the on-going TWT SP. If an AP receives zero buffer status from a STA during an on-going SP, the AP may terminate the SP for the corresponding STA.

In some embodiments, a STA can indicate (readiness, intention and/or request of) early termination of a TWT SP using zero buffer status for all traffic (e.g., all TIDs), only when delivering the zero buffer status as an unsolicited response. For example, (1) if an AP receives a zero buffer status indication in BSR for all TIDs (e.g., using the queue size all subfield 736) corresponding to an on-going SP as an unsolicited response, and (2) if the AP has also delivered all traffic to the STA, the AP may terminate the SP. Similarly, a STA can indicate (readiness, intention and/or request of) early termination of a TWT SP using zero buffer status for any TID, only when delivering the zero buffer status as an unsolicited response. For example, (1) if an AP receives a zero buffer status indication in BSR for any TID (e.g., using the queue size high subfield 735) corresponding to an on-going SP as an unsolicited response, and (2) if the AP has also delivered all traffic to the STA, the AP may terminate the SP.

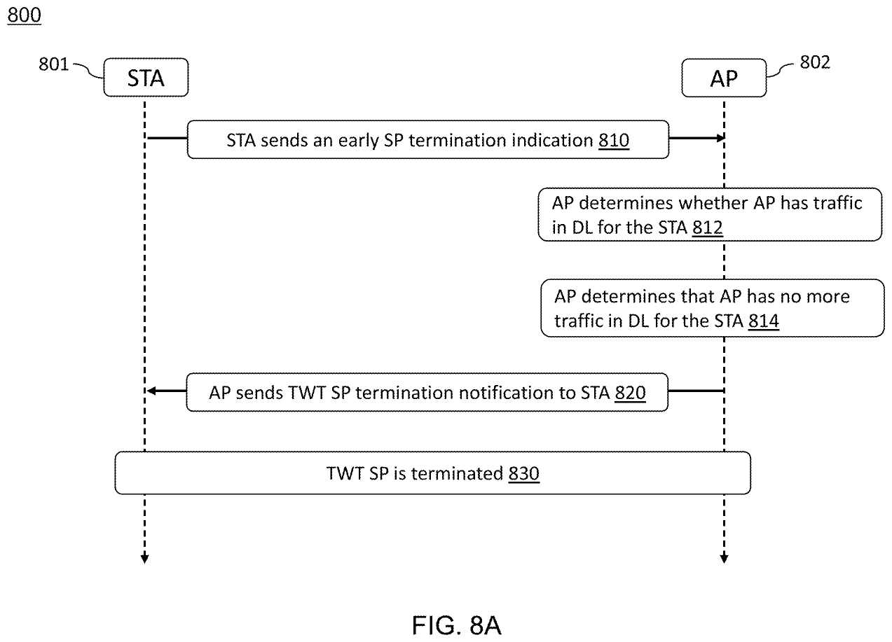

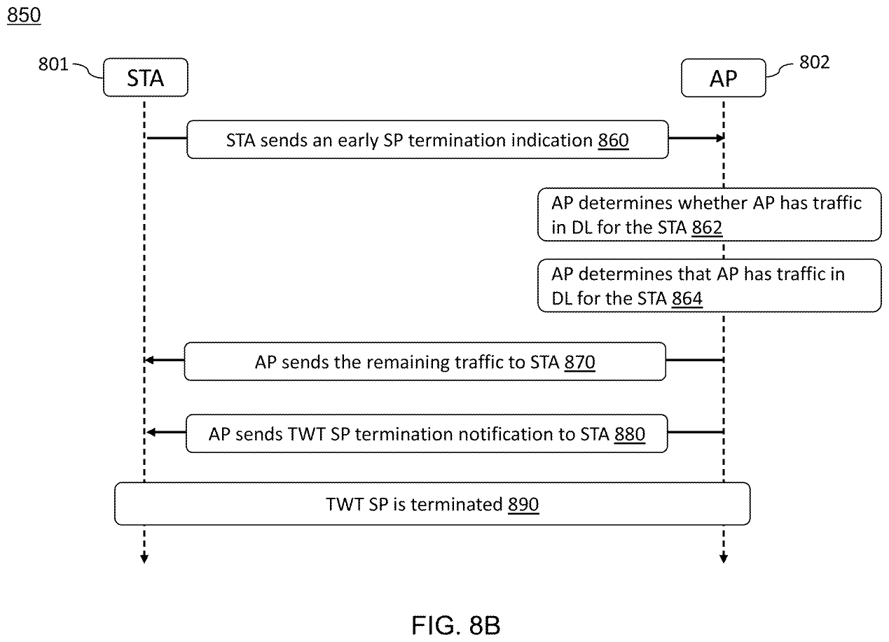

FIG. 8A and FIG. 8B illustrate example frame sequences 800, 850 for early termination of a TWT SP, according to an example implementation of the present disclosure. Referring to FIG. 8A, at step 810, a STA 801 (e.g., computing device 110A, 110B, HWD 150A, 150B) may send, to an AP 802 (e.g., AP 105), an indication of early termination of an on-going SP of a TWT (e.g., using either EOT subfield 550 in FIG. 5, or solicited or unsolicited zero buffer status report (QOS control field 600 in FIG. 6 or BSR control field 730 in FIG. 7)). At step 812, the AP 802 may determine whether the AP has traffic in DL for the STA 801 for the remainder of the on-going SP. At step 814, the AP 802 may determine that the AP has no more traffic in DL for the STA 801 for the remainder of the on-going SP. At step 820, the AP 802 may send an SP termination notification to the STA 801. At step 830, the on-going SP of the TWT may be terminated.

Referring to FIG. 8B, at step 860, the STA 801 may send, to the AP 802, an indication of early termination of an on-going SP of a TWT (e.g., using either EOT subfield 550 in FIG. 5, or solicited or unsolicited zero buffer status report (QOS control field 600 or BSR control field 730)). At step 862, the AP 802 may determine whether the AP has traffic in DL for the STA 801 for the remainder of the on-going SP. At step 864, the AP 802 may determine that the AP has traffic in DL for the STA 801 for the remainder of the on-going SP. At step 870, the AP 802 may send (all of) the remaining traffic to the STA 801. At step 880, the AP 802 may send an SP termination notification to the STA 801. In some embodiments, the SP termination notification sent at step 880 can be indicated in a last DL data frame sent by the AP 802 at step 870. At step 890, the on-going SP of the TWT may be terminated. In some embodiments, the AP 802 may terminate an on-going SP only after receiving the early SP termination indication from the STA 801.

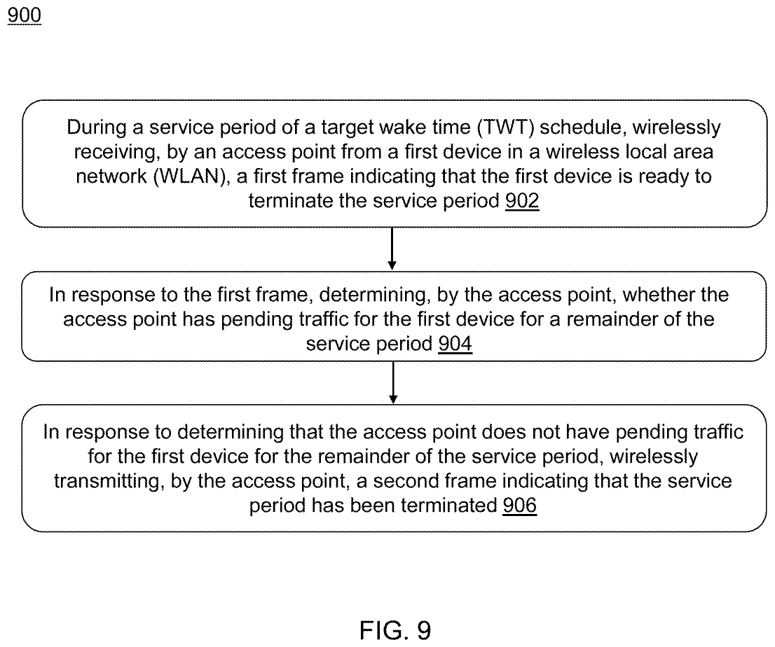

FIG. 9 is a flowchart showing a process 900 of performing early termination of a TWT SP, according to an example implementation of the present disclosure. In some embodiments, the process 900 is performed by an access point (e.g., AP 105 or AP 802). In some embodiments, the process 900 is performed by other entities. In some embodiments, the process 900 includes more, fewer, or different steps than shown in FIG. 9.

In one approach, during a service period of a TWT schedule, the access point may wirelessly receive 902, from a first device (e.g., computing device 110A, 110B, HWD 150A, 150B, STA 801) in a wireless local area network (WLAN), a first frame indicating that the first device is ready to terminate the service period. In some embodiments, the access point may wirelessly send a fourth frame (e.g., BSRP trigger frame). In response to the fourth frame, the access point may wirelessly receive the first frame (e.g., frame carrying zero buffer status using a QoS control field 600 or a BSR control field 730).

In some embodiments, the first frame may include a QoS control field (e.g., QoS control field 500) that includes a first field (e.g., the fourth subfield 504 as EOT/EOTSP subfield 550). The first field may be set to a value (e.g., value 1) indicating that the first device is ready to terminate the service period. The first frame may be a QoS null frame (e.g., frame 530). The first field may be a bit (e.g., bit 7) included in the QoS control field (e.g., QoS control field 500).

In some embodiments, the first frame may include a second field (e.g., the queue size high subfield 735) indicating a buffer size of traffic corresponding a TID (e.g., TID indicated in the ACI high subfield 733). The second field may be set to a value (e.g., value 0) indicating that the first device is ready to terminate the service period. In some embodiments, the first frame may include a third field (e.g., the queue size all subfield 736) indicating a total buffer size of traffic corresponding a plurality of TIDs (e.g., TIDs indicated in the ACI bitmap subfield 731 and the delta TID subfield 732). The third field may be set to a value (e.g., value 0) indicating that the first device is ready to terminate the service period.

In one approach, in response to the first frame, the access point may determine 904 whether the access point has pending traffic for the first device for a remainder of the service period (e.g., step 812 and step 862 in FIG. 8A and FIG. 8B, respectively). In one approach, in response to determining that the access point does not have pending traffic for the first device for the remainder of the service period (e.g., step 814), the access point may wirelessly transmit 906 a second frame (e.g., TWT SP termination notification) indicating that the service period has been terminated. In some embodiments (e.g., step 820), in response to determining that the access point has pending traffic for the first device for the remainder of the service period (e.g., step 864), the access point may wirelessly transmit, to the first device, the pending traffic (e.g., step 870). In response to transmitting the pending traffic, the access point may wirelessly transmit a third frame (e.g., TWT SP termination notification) indicating that the service period has been terminated (e.g., step 880).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
generate, during a service period of a target wake time (TWT) schedule, a first frame indicating, to an access point in a wireless local area network (WLAN), that the first device is ready to terminate the service period; and
wirelessly transmit, via a transceiver, the generated first frame to the access point.

2. The first device according to claim 1, wherein:
the first frame includes a quality of service (QOS) control field that includes a first field, and
in generating the first frame, the one or more processors are configured to set the first field to a value indicating that the first device is ready to terminate the service period.

3. The first device according to claim 2, wherein:
the first frame is a QoS null frame, and
the first field is a bit included in the QoS control field.

4. The first device according to claim 1, wherein:
the first frame includes a second field indicating a buffer size of traffic corresponding a traffic identifier (TID), and
in generating the first frame, the one or more processors are configured to set the second field to a value indicating that the first device is ready to terminate the service period.

5. The first device according to claim 1, wherein:
the first frame includes a third field indicating a total buffer size of traffic corresponding a plurality of TIDs, and
in generating the first frame, the one or more processors are configured to set the third field to a value indicating that the first device is ready to terminate the service period.

6. The first device according to claim 1, wherein the one or more processors are further configured to:
wirelessly receive, via the transceiver from the access point, a second frame; and
in response to the second frame, generate the first frame.

7. An access point comprising:
one or more processors configured to:
wirelessly receive, during a service period of a target wake time (TWT) schedule, via a transceiver from a first device in a wireless local area network (WLAN), a first frame indicating that the first device is ready to terminate the service period;
in response to the first frame, determine whether the access point has pending traffic for the first device for a remainder of the service period; and
in response to determining that the access point does not have pending traffic for the first device for the remainder of the service period, wirelessly transmit, via the transceiver, a second frame indicating that the service period has been terminated.

8. The access point according to claim 7, wherein the one or more processors are further configured to:
in response to determining that the access point has pending traffic for the first device for the remainder of the service period, wirelessly transmit, via the transceiver to the first device, the pending traffic; and
in response to transmitting the pending traffic, wirelessly transmit, via the transceiver, a third frame indicating that the service period has been terminated.

9. The access point according to claim 7, wherein:
the first frame includes a quality of service (QOS) control field that includes a first field, and
the first field is set to a value indicating that the first device is ready to terminate the service period.

10. The access point according to claim 9, wherein:
the first frame is a QoS null frame, and
the first field is a bit included in the QoS control field.

11. The access point according to claim 7, wherein:
the first frame includes a second field indicating a buffer size of traffic corresponding a traffic identifier (TID), and
the second field is set to a value indicating that the first device is ready to terminate the service period.

12. The access point according to claim 7, wherein:
the first frame includes a third field indicating a total buffer size of traffic corresponding a plurality of TIDs, and
the third field is set to a value indicating that the first device is ready to terminate the service period.

13. The access point according to claim 7, wherein the one or more processors are further configured to:
wirelessly send, via the transceiver of the access point, a fourth frame; and
in response to the fourth frame, wirelessly receive, via the transceiver, the first frame.

14. A method comprising:
during a service period of a target wake time (TWT) schedule, wirelessly receiving, by an access point from a first device in a wireless local area network (WLAN), a first frame indicating that the first device is ready to terminate the service period;
in response to the first frame, determining, by the access point, whether the access point has pending traffic for the first device for a remainder of the service period; and
in response to determining that the access point does not have pending traffic for the first device for the remainder of the service period, wirelessly transmitting, by the access point, a second frame indicating that the service period has been terminated.

15. The method according to claim 14, further comprising:
in response to determining that the access point has pending traffic for the first device for the remainder of the service period, wirelessly transmitting, by the access point to the first device, the pending traffic; and
in response to transmitting the pending traffic, wirelessly transmitting, by the access point, a third frame indicating that the service period has been terminated.

16. The method according to claim 14, wherein:
the first frame includes a quality of service (QOS) control field that includes a first field, and
the first field is set to a value indicating that the first device is ready to terminate the service period.

17. The method according to claim 16, wherein:
the first frame is a QoS null frame, and
the first field is a bit included in the QoS control field.

18. The method according to claim 7, wherein:
the first frame includes a second field indicating a buffer size of traffic corresponding a traffic identifier (TID), and
the second field is set to a value indicating that the first device is ready to terminate the service period.

19. The method according to claim 7, wherein:
the first frame includes a third field indicating a total buffer size of traffic corresponding a plurality of TIDs, and
the third field is set to a value indicating that the first device is ready to terminate the service period.

20. The method according to claim 14, further comprising:
wirelessly sending, by the access point, a fourth frame; and
in response to the fourth frame, wirelessly receiving, by the access point, the first frame.
